(19) United States
(12) Patent Application Publication
(10) Pub. No.: US 2017/0048764 A1
(43) Pub. Date: Feb. 16, 2017

(54) Methods to Improve Single Radio Long Term Evolution (SRLTE) Performance

(71) Applicant: QUALCOMM Incorporated, San Diego, CA (US)

(72) Inventors: Bhaskara Viswanadham Batchu, Hyderabad (IN); Aditya Bohra, Surat (IN); Sharad Shahi, Boulder, CO (US)

(21) Appl. No.: 14/824,274

(22) Filed: Aug. 12, 2015

(51) Int. Cl. H04W 36/00; H04W 24/02; H04B 1/7075; H04L 5/00

(52) U.S. Cl. CPC H04W 36/0094; H04L 5/0048; H04W 24/02; H04B 1/70754

(57) ABSTRACT

Various embodiments provide methods, devices, and non-transitory processor-readable storage media for reducing subscription reacquisition times in single radio long term evolution (SRLTE) communication devices. In various embodiments, a processor of the SRLTE communication device may calculate an expected pilot slew error in response to a radio frequency (RF) resource of the SRLTE communication device becoming available to a first subscription following a declared system loss of the first subscription. The processor may determine a dynamic search window size based at least in part on the expected pilot slew error. The processor may find a pilot signal using the dynamic search window size. Using the pilot signal determined in this manner the processor may reacquire a network associated with the first subscription.

### BACKGROUND

Mobile communication devices—such as smart phones—may be single radio long term evolution (SRLTE) communication devices in which a single radio frequency (RF) resource supports both data and voice calls in a mobile telephony network (e.g., Code Division Multiple Access (CDMA) networks, Global System for Mobile Communications (GSM) networks, Wideband CDMA (WCDMA) networks, etc.).

Some SRLTE communication devices may be multi-subscription communication devices in which two or more subscriptions are supported by a single RF resource. Examples of multi-subscription communication devices include multi-Subscriber-Identity-Module (SIM) (multi-SIM) multi-standby communication (MSMS) devices, dual-SIM communication dual-standby (DSDS) devices, three subscriptions or triple-SIM communication devices, and four subscriptions or quad-SIM communication devices. The sharing of the single RF resource by the plurality of subscriptions results in only one of the plurality of subscriptions having control of the RF resource at any given time, thus the two or more subscriptions share the RF resource by alternately using it to communicate with each subscription's network (thus the term “multi-standby”).

When a first subscription controls the RF resource for a duration longer than an access threshold for a second subscription (a duration after which a connection with a network may be lost), the second subscription may declare a system loss due to the non-availability of the RF resource. The declaration of a system loss by the second subscription causes the second subscription to perform reacquisition operations when the RF resource again becomes available. The reacquisition operations by the second subscription may require the second subscription to control the RF resource for longer than the access threshold of the first subscription, resulting in the first subscription declaring a system loss and having to perform reacquisition operations.

### SUMMARY

Various embodiments provide methods, devices, and non-transitory processor-readable storage media for reducing subscription reacquisition times in single radio long term evolution (SRLTE) communication devices. Various embodiments provide methods, devices, and non-transitory processor-readable storage media for reacquiring a network following a declared system loss in a SRLTE communication device. Various embodiments may include calculating an expected pilot slew error in response to a radio frequency (RF) resource of the SRLTE communication device becoming available to a first subscription of the SRLTE communication device following a declared system loss of the first subscription, determining a dynamic search window size based at least in part on the expected pilot slew error, finding a pilot signal using the dynamic search window size, and reacquiring a network associated with the first subscription using the pilot signal.

In some embodiments, the methods may further include determining a pilot slew error based on the pilot signal and determining a current system time based at least in part on the determined pilot slew error, and reacquiring the network associated with the first subscription using the pilot signal may include reacquiring the network associated with the first subscription using the pilot signal and the determined current system time. In some embodiments, determining a current system time based at least in part on the determined pilot slew error may include determining a current system time as an elapsed time since the first subscription last had control of the RF resource plus the determined pilot slew error.

In some embodiments, the methods may further include retrieving a common frequency error correction value from a memory of the SRLTE communication device, and reacquiring the network associated with the first subscription using the pilot signal and the determined current system time may include reacquiring the network associated with the first subscription using the pilot signal, the determined current system time, and the common frequency error correction value. In some embodiments, the methods may further include determining the common frequency error correction value by a second subscription of the SRLTE communication device. In some embodiments, the method may further include determining the common frequency error correction value by an entity of the SRLTE communication device other than a subscription.

In some embodiments, determining a dynamic search window size based at least in part on the expected pilot slew error may include determining a dynamic search window size as a current window size plus the expected pilot slew error.

In some embodiments, calculating an expected pilot slew error comprises calculating an expected pilot slew error based at least in part on an elapsed time since the first subscription last had control of the RF resource and a characterized slew error stored in a memory of the SRLTE communication device.

Various embodiments may include a communication device, such as an SRLTE communication device, configured with processor-executable instructions to perform operations of the methods described above.

Various embodiments may include a communication device, such as an SRLTE communication device, having means for performing functions of the operations of the methods described above.

Various embodiments may include non-transitory processor-readable media on which are stored processor-executable instructions configured to cause a processor of a communication device, such as an SRLTE communication device, to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a communication system block diagram of a network suitable for use with the various embodiments.

FIG. 2 is a block diagram illustrating a single radio long-term evolution (SRLTE) communication device according to various embodiments.

FIG. 3 is a timeline diagram illustrating control of a RF resource by subscriptions of an SRLTE communication device.

FIG. 4 is a process flow diagram illustrating a method for updating common frequency error correction values according to various embodiments.

FIG. 5 is a process flow diagram illustrating a method for reducing subscription reacquisition times in SRLTE communication devices.

FIGS. 6A, 6B, and 6C are frequency diagrams illustrating different pilot peak positions and different acquisition windows.

FIG. 7 is a timeline diagram illustrating control of a RF resource by subscriptions of an SRLTE communication device according to various embodiments.

FIG. 8 is a component block diagram of a communication device suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims.

Various embodiments provide methods, devices, and non-transitory processor-readable storage media for reducing subscription reacquisition times in single radio long-term evolution (SRLTE) communication devices, especially SRLTE communication devices having multi-subscriptions (e.g., having multi-Subscriber-Identity-Modules (SIMs)), such as two subscriptions (e.g., dual-SIM communication devices), three subscriptions (e.g., triple-SIM communication devices), four subscriptions (e.g., quad-SIM communication devices), or more subscriptions, that are all supported by a single radio frequency (RF) resource. In various embodiments, the different subscriptions of the SRLTE communication device may be subscriptions associated with different networks, such as Code Division Multiple Access (CDMA) networks (e.g., CDMA 2000 1× networks), Wideband CDMA (WCDMA) networks, and/or Global System for Mobile Communications (GSM) networks (e.g., GSM with Discontinuous Reception (DRx) networks).

The term “communication device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways. The various aspects may be useful in single radio long-term evolution (SRLTE) communication devices, such as smart phones, and so such devices are referred to in the descriptions of various embodiments. However, the embodiments may be useful in any electronic devices in which a single radio frequency resource (RF resource) supports both data and voice calls in one or more mobile telephony networks, such as CDMA networks (e.g., CDMA 2000 1× networks), WCDMA networks, and/or GSM networks (e.g., GSM DRx networks).

SRLTE communication devices may exhibit out of service issues and degraded subscription performance due to subscriptions declaring system loss when the subscriptions loses access to the shared RF resource for longer than an access threshold. For example, when an SRLTE communication device supporting a GSM DRx (discontinuous reception) subscription enters a traffic/access state (e.g., to conduct a data call) that controls the RF resource and prevents tune-away of the RF resource for more than one minute, this control of the RF resource may exceed the access threshold of a CDMA 2000 1× subscription sharing the RF resource. As a result, the CDMA 2000 1× subscription may declare a system loss and may miss any Mobile Terminated (MT) paging messages for the CDMA 2000 1× subscription during the time the RF resource is controlled by the GSM DRx subscription.

Once the GSM DRx subscription releases the RF resource, the CDMA 2000 1× subscription will undertake operations to reacquire the CDMA 2000 1× network (e.g., channel scanning, pilot acquisition, system time determination, overhead collection, etc.), which may take 5 to 10 seconds. During the CDMA 2000 1× reacquisition operations the GSM DRx subscription is prevented from taking control of the RF resource (e.g., prevented from causing tune-away). Consequently, the GSM DRx subscription may miss page slots and MT paging messages. Specifically, when the CDMA 2000 1× subscription has a reacquisition time of 10 seconds, a GSM DRx subscription with a DRx cycle of 470 milliseconds will miss 21 page slots (i.e., 10 seconds/470 milliseconds=21). Additionally, the GSM DRx subscription may declare a system loss when the reacquisition operations exceed the GSM DRx subscription's access threshold, which may result in out of service issues for both the CDMA 2000 1× subscription and the GSM DRx subscription.

Various embodiments overcome performance issues of SRLTE communication devices by storing common frequency error correction values and using stored common frequency error correction values to reacquire a network after obtaining use of the shared RF resource. As used herein the term “common frequency error correction value” refers to a frequency error correction value stored in a memory location common to all subscriptions of the SRLTE communication device such that the common frequency error correction values stored in the memory location may be used by all subscriptions of the SRLTE communication device. While a subscription of an SRLTE communication device controls the RF resource, the subscription may update common frequency error correction values available for use by all subscriptions operating on the SRLTE communication device. For example, when a subscription controlling the RF resource at a given time determines a frequency error correction, that subscription may pass the determined frequency error correction to an entity on the SRLTE device that tracks frequency errors, such as a common frequency error manager of the modem, a common frequency error management unit of a reacquisition management unit separate from the modem, etc. The entity on the SRLTE device that tracks frequency errors may update a common listing of frequency error corrections that is stored in a memory for use by all subscriptions of the SRLTE communication device.

As another example, when a subscription controlling the RF resource at a given time determines a frequency error correction, that subscription may store the frequency error correction in a memory location common to all subscriptions of the SRLTE communication device dedicated to common frequency error correction values storage. As a further example, an entity of an SRLTE communication device other than a subscription, such as a common frequency error manager of the modem, a common frequency error management unit of a reacquisition management unit separate from the modem, etc., may control the RF resource at a given time to determine a frequency error correction. The entity of the SRLTE communication device other than a subscription may store the frequency error correction in a memory location common to all subscriptions of the SRLTE communication device dedicated to common frequency error correction values storage.

In various embodiments, whether a common frequency error correction value is stored by an entity on the SRLTE device that tracks frequency errors, by the determining subscription itself, or in some other manner, when a different subscription takes control of the RF resource, the different subscription may retrieve the common frequency error correction value and use the common frequency error correction value to reacquire the network associated with that different subscription that now has control of the RF resource. By using the common frequency error correction values, each subscription taking control of the RF resource may avoid performing overhead information collection that would otherwise be required to gather error correction values. Eliminating the need to perform overhead information collection by using stored common frequency error correction values may speed up the reacquisition time of a subscription as compared to the reacquisition time of a subscription that performs overhead information collection. Thus, the various embodiments may shorten the time that each subscription controls a shared RF resource under certain circumstances.

In various embodiments, a first subscription may retrieve the common frequency error correction values provided by another subscription or another entity of a SRLTE communication device, and the first subscription may reacquire the network using the retrieved common frequency error correction values along with the pilot signal and the current system time. This system reacquisition procedure using the pilot signal, determined current system time, and common frequency error correction values may be faster than a reacquisition using a pilot signal, a network obtained system time, and collected overhead information. For example, a CDMA 2000 1× subscription performing reacquisition using a pilot signal, a network obtained system time, and collected overhead information may take 5 to 10 seconds to reacquire signals from a network associated with the subscription, as opposed to a CDMA 2000 1× subscription performing reacquisition using the pilot signal, determined current system time, and common frequency error correction values that may take less than 100 milliseconds to reacquire signals from a network associated with the subscription.

In various embodiments, a subscription may obtain the pilot signal by calculating an expected pilot slew error or conventional channel scanning, depending on whether or not the time duration since the system loss was declared was less than a recovery time threshold. When a subscription receives control of the RF resource of an SRLTE communication device after declaring a system loss, the subscription may determine whether the time duration since the system loss was declared was less than a recovery time threshold. The time duration since the system loss was declared may be determined by the difference between the current clock time of the SRLTE communication device and a time associated with the system loss declaration event. A recovery time threshold may be a value stored in memory that may be configurable by a user, original equipment manufacturer, and/or network operator. The recovery time threshold may represent an amount of time after which attempting to dynamically size a search window for a pilot signal may be of negligible value in improving the speed at which an active pilot signal or neighbor pilot signal may be found.

In various embodiments, when the time duration since the system loss was declared is less than the recovery time threshold the subscription may calculate an expected pilot slew error. The expected pilot slew error may be a frequency value derived based on the elapsed time since the subscription last had control of the RF resource and the characterized slew error previously determined by the subscription when it last had control of the RF resource. The characterized slew error may be derived by a subscription operating in a slotted mode each time the subscription has control of the RF resource and may be stored in a memory of the SRLTE communication device. The elapsed time since the subscription last had control of the RF resource (also sometimes referred to as a slept time) may be tracked by the subscription (e.g., by counting clock ticks) from the time the subscription relinquished control of the RF resource.

In various embodiments, the expected pilot slew error may be determined as equal to the characterized slew error multiplied by the result of dividing the elapsed time since the subscription last had control of the RF resource by the subscription's slot cycle index. The subscription's slot cycle index may be a value stored in memory associated with the period of time allocated to the subscription to control the RF resource when operating in a slotted mode.

In various embodiments, the expected slew error may be used by the subscription of the SRLTE communication device to determine a dynamic search window size. The dynamic search window size may be a frequency range determined as equal to the current window size of the subscription plus the expected pilot slew error. The current window size may be a frequency range stored in a memory of the SRLTE communication device over which the subscription may attempt to find active or neighbor pilot signals. Changes in the pilot signal over the time since the subscription last had control of the RF resource may be accounted for by adding the expected slew error to the current window size because the dynamic search window size may be a larger frequency range than the current window size. The subscription may use the dynamic search window size to search for all active and available neighbor pilots in that frequency range and thereby find a pilot signal. In this manner, the subscription may avoid channel scanning for all possible pilots and may acquire a pilot signal using the dynamic search window size faster than a pilot would have been acquired by channel scanning. Once a pilot is found, the pilot may be used to determine the pilot slew error as a value of time.

In various embodiments, the current system time may be determined based at least in part on the determined pilot slew error. In various embodiments, the elapsed time since the subscription last had control of the RF resource (also sometimes referred to as a slept time) plus the determined pilot slew error may be equal to the current system time. The elapsed time since the subscription last had control of the RF resource (also sometimes referred to as a slept time) may be tracked by the subscription counting clock ticks from the time the subscription relinquished control of the RF resource.

In various embodiments, when the time duration since the system loss was declared equals or exceeds the recovery time threshold, the subscription may default to finding a pilot signal (e.g., an active pilot signal or neighbor pilot signal) by conventional channel scanning. For example, when the time duration since a CDMA 2000 1× subscription last controlled the RF resource of an SRLTE communication device is larger than the recover threshold time, the resulting dynamic search window's size may be so large that every pilot signal possibility must be tested to find the active pilot signal. In this situation, testing every pilot signal possibility may be no faster than finding the pilot signal via channel scanning, and therefore there would be no time savings for subscription acquisition. As there would be no time savings for subscription acquisition, the subscription may default to channel scanning because dynamically sizing the search window may not reduce system reacquisition time. After finding an active pilot signal or neighbor pilot signal by channel scanning, the subscription may obtain the system time from the network, perform overhead information collection, and reacquire signals from a network associated with the subscription using the pilot signal, the obtained system time, and the collected overhead information in a manner similar to conventional subscription system reacquisition operations.

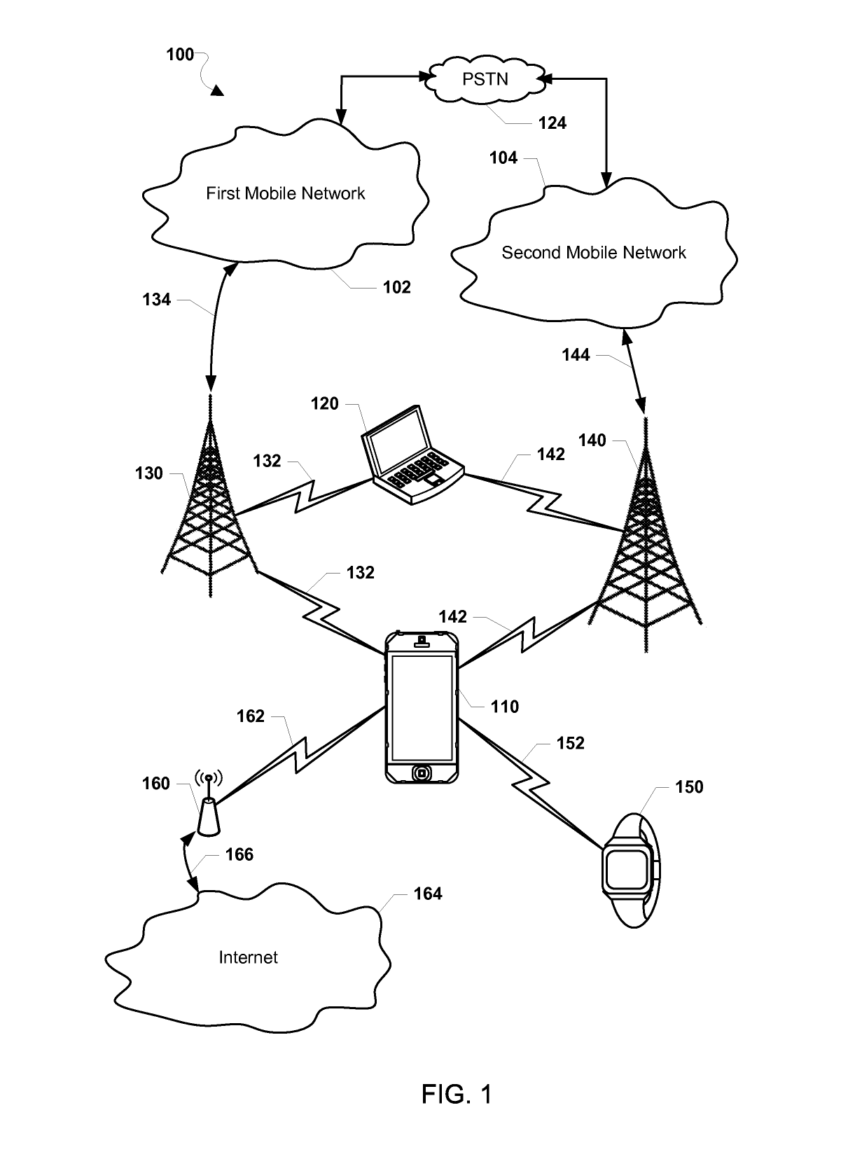

Various embodiments may be implemented within a variety of communication systems 100, an example of which is illustrated in FIG. 1. A first mobile network 102 and a second mobile network 104 typically each include a plurality of cellular base stations (e.g., a first base station 130 and a second base station 140). The networks 102, 104 may also be referred to by those of skill in the art as access networks, radio access networks, base station subsystems (BSSs), UMTS Terrestrial Radio Access Networks (UTRANs), etc. The networks 102, 104 may use the same or different wireless interfaces and/or physical layers. In an embodiment, the base stations 130, 140 may be controlled by one or more base station controllers (BSCs). Alternate network configurations may also be used and the embodiments are not limited to the configuration illustrated.

A first SRLTE communication device 110 may be in communication with the first mobile network 102 through a cellular connection 132 to the first base station 130. The first SRLTE communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second SRLTE communication device 120 may similarly communicate with the first mobile network 102 through the cellular connection 132 to the first base station 130. The second SRLTE communication device 120 may communicate with the second mobile network 104 through the cellular connection 142 to the second base station 140.

The cellular connections 132 and 142 may be made through two-way wireless communication links, such as GSM (e.g., GSM DRx), Universal Mobile Telecommunications Systems (UMTS) (e.g., Long Term Evolution (LTE)), Frequency Division Multiple Access (FDMA), Time Division Multiple Access (TDMA), CDMA (e.g., CDMA 2000 1×), WCDMA, Wi-Fi, Personal Communications (PCS), Third Generation (3G), Fourth Generation (4G), Fifth Generation (5G), or other mobile telephony communication technologies.

In various embodiments, the SRLTE communication devices 110, 120 may access networks 102, 104 after camping on cells managed by the base stations 130, 140. In some embodiments, the SRLTE communication devices 110, 120 may engage in one active communication at a time, such as a single data call or single voice call.

In the system 100, the SRLTE communication devices 110, 120 may be multi-SIM communication devices that are capable of operating with a number of wireless networks enabled by information stored in a plurality of SIMs. Using dual-SIM functionality, the SRLTE communication devices 110, 120 may access the two networks 102, 104 by camping on cells managed by the base stations 130, 140.

While the SRLTE communication devices 110, 120 are shown connected to the mobile networks 102, 104, in some embodiments (not shown), the SRLTE communication devices 110, 120 may include one or more subscriptions to two or more mobile networks 102, 104 and may connect to those networks in a manner similar to operations described above.

In some embodiments, the first SRLTE communication device 110 may establish a wireless connection 152 with a peripheral device 150 used in connection with the first SRLTE communication device 110. For example, the first SRLTE communication device 110 may communicate over a Bluetooth® link with a Bluetooth-enabled personal computing device (e.g., a “smart watch”). In some embodiments, the first SRLTE communication 110 may establish a wireless connection 162 with a wireless access point 160, such as over a Wi-Fi connection. The wireless access point 160 may be configured to connect to the Internet 164 or another network over a wired connection 166.

While not illustrated, the second SRLTE communication device 120 may similarly be configured to connect with the peripheral device 150 and/or the wireless access point 160 over wireless links.

The networks 102, 104 may be interconnected by public switched telephone network (PSTN) 124, across which the networks 102, 104 may route various incoming and outgoing communications to the SRLTE communication devices 110, 120.

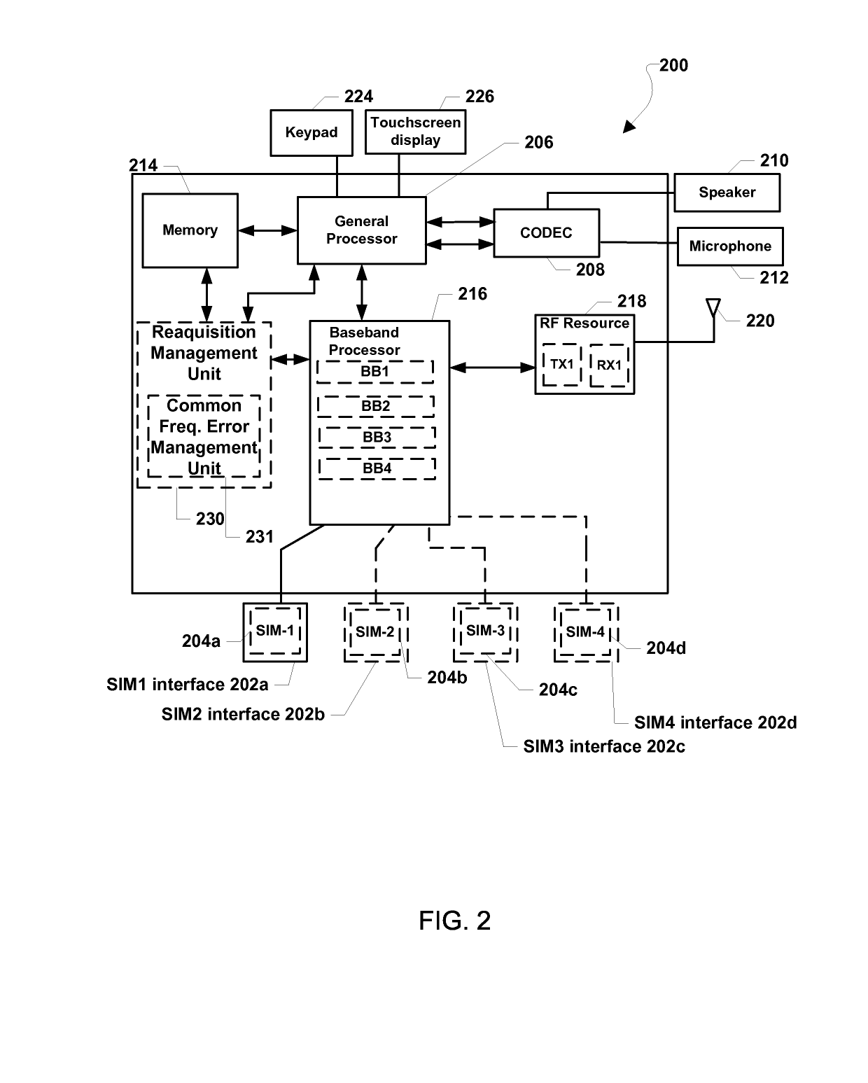

FIG. 2 is a functional block diagram of an example SRLTE communication device 200 that is suitable for implementing various embodiments. With reference to FIGS. 1-2, the SRLTE communication device 200 may be similar to one or more of the SRLTE communication devices 110, 120. The SRLTE communication device 200 may include a first SIM interface 202a, which may receive a first identity module SIM 204a that is associated with the first subscription. The SRLTE communication device 200 may also include a second SIM interface 202b, which may receive a second identity module SIM 204b that is associated with the second subscription. In some embodiments, the SRLTE communication device 200 may also include a third SIM interface 202c, which may receive a third identity module SIM 204c that is associated with the third subscription. In further embodiments, the SRLTE communication device 200 may also include a fourth SIM interface 202d, which may receive a fourth identity module SIM 204d that is associated with the fourth subscription.

A SIM, in various embodiments, may be a Universal Integrated Circuit Card (UICC) that is configured with SIM and/or Universal SIM (USIM) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the SRLTE communication device 200 (e.g., memory 214), and thus need not be a separate or removable circuit, chip or card.

The SRLTE communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general processor 206 and the memory 214 may each be coupled to at least one baseband modem processor 216. Each SIM 204a, 204b, 204c, 204d in the SRLTE communication device 200 may share a baseband-RF resource chain. A baseband-RF resource chain may include the baseband modem processor 216, which may perform baseband/modem functions for communicating with/controlling a RAT, and may include one or more amplifiers and radios, referred to generally herein as RF resources (e.g., RF resources 218). The RF resource 218 may be coupled to antenna 220 and may perform transmit/receive functions for the wireless services associated with each SIM 204a, 204b, 204c, 204d of the SRLTE communication device 200. The RF resource 218 may provide separate transmit and receive functionality, or may include a transceiver that combines transmitter and receiver functions.

In some embodiments, the general processor 206, the memory 214, the baseband processor(s) 216, and the RF resources 218 may be included in the SRLTE communication device 200 as a system-on-chip. In some embodiments, the SIMs 204a, 204b, 204c, 204d and the corresponding interfaces 202a, 202b, 202c, 202d may be external to the system-on-chip. Further, various input and output devices may be coupled to components on the system-on-chip, such as interfaces or controllers. Example user input components suitable for use in the SRLTE communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software modules and functions in the SRLTE communication device 200 to enable communication between them.

The SRLTE communication device 200 may include a reacquisition management unit 230 (also referred to as a reacquisition manager) configured to manage each subscriptions' reacquisition of the associated network via the RF resource 218. The SRLTE communication device 200 may also include a common frequency error management unit 231 (also referred to as a common frequency error manager) configured to manage and/or monitor common frequency error values provided by an active subscription.

In some embodiments, the reacquisition management unit 230 and/or the common frequency error management unit 231 may be implemented within the general processor 206. In some embodiments, the reacquisition management unit 230 and/or the common frequency error management unit 231 may be implemented as a separate hardware component (i.e., separate from the general processor 206). In some embodiments, the reacquisition management unit 230 and/or the common frequency error management unit 231 may be implemented as a software application stored within the memory 214 and executed by the general processor 206.

In some embodiments, the common frequency error management unit 231 may be a subcomponent of the reacquisition management unit 230. In some embodiments, the common frequency error management unit 231 may be separate from the reacquisition management unit 230. In various embodiments, the reacquisition management unit 230, common frequency error management unit 231, baseband modem processor 216, RF resource 218 and/or SIMs 204a, 204b, 204c, 204d may be implemented in hardware, software, firmware, or any combination thereof.

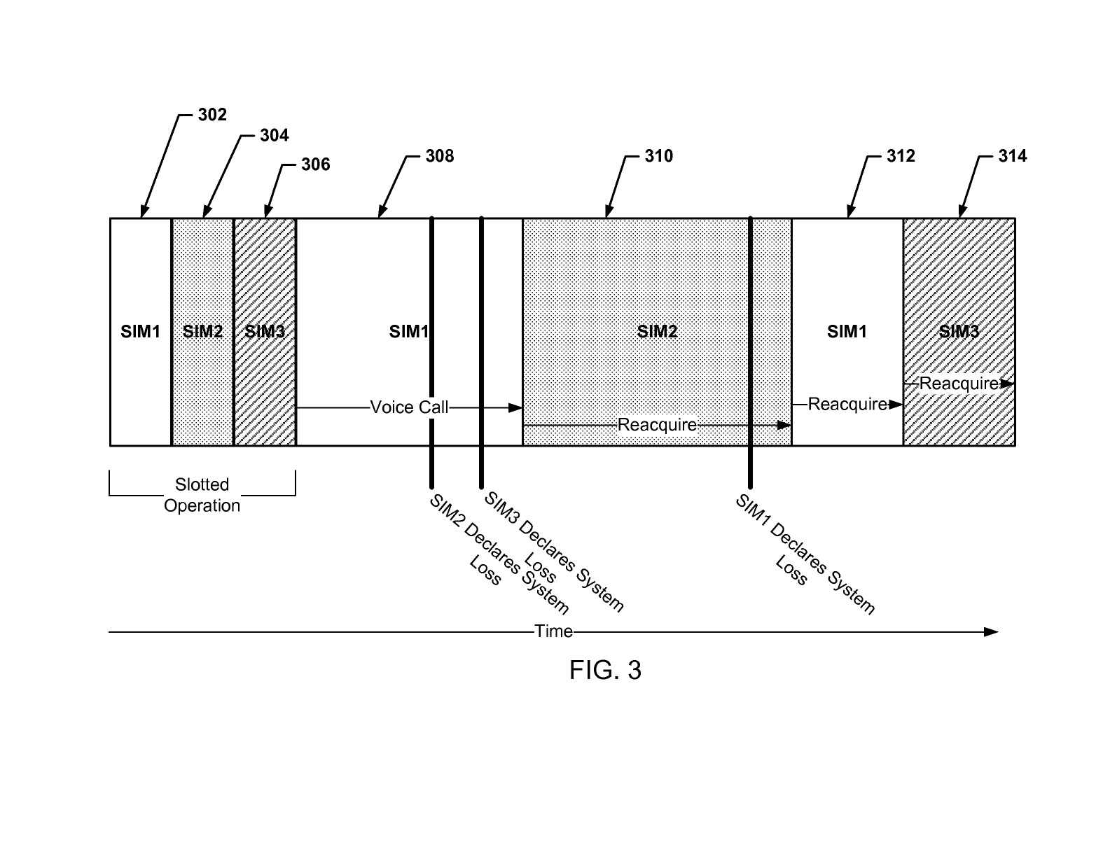

FIG. 3 is a timeline diagram 300 illustrating control of a shared RF resource of an SRLTE communication device by a GSM DRx subscription associated with SIM1, a CDMA 2000 1× subscription associated with SIM2, and a GSM DRx subscription associated with SIM3 of an SRLTE communication device. With reference to FIGS. 1-3, initially the three subscriptions SIM1, SIM2, and SIM3 may be operating in a slotted mode periodically passing control of the RF resource among one another. For example, SIM1 may control the RF resource for a time period 302 of 470 milliseconds, after which SIM2 may control the RF resource for a time period 304 of 470 milliseconds, and then SIM3 may control the RF resource for a time period 306 of 470 milliseconds.

In time period 308, the GSM DRx subscription associated with SIM1 may conduct a voice call, and during the voice call may not relinquish control of the RF resource to the other subscriptions associated with SIM2 and SIM3. The long duration that the subscriptions associated with SIM2 and SIM3 may go without monitoring the subscriptions' respective network via the RF resource may cause each of the subscriptions associated with SIM2 and SIM3 to declare a system loss. For example, the CDMA 2000 1× subscription associated with SIM2 may declare a system loss when the RF resource is not available for more than 1 minute because, after a minute without controlling the RF resource, the CDMA 2000 1× subscription associated with SIM2 is unable to track network time, clock drift and clock errors may occur, and/or potentially the SRLTE communication device may have moved out of a coverage area.

In time period 310, the CDMA 2000 1× subscription associated with SIM2 may gain control of the RF resource after the voice call ends and initiate a process to reacquire a connection to a network supporting the subscription. This reacquisition process may take a long period of time, such as 5 to 10 seconds, when the CDMA 2000 1× subscription associated with SIM2 performs channel scanning to find a pilot signal, obtain system time from the network, and perform overhead collection. During this period of 5 to 10 seconds, the other subscriptions may be prevented from controlling the RF resource. As a result of this duration without access to the shared RF resource, the GSM DRx subscription associated with SIM1 may declare a system loss.

Additionally, while the CDMA 2000 1× subscription associated with SIM2 is reacquiring the system and exclusively controlling the RF resource, the GSM DRx subscription associated with SIM1 may miss MT page messages and thus not activate any incoming MT calls. When the CDMA 2000 1× subscription associated with SIM2 acquires a network connection and releases control of the RF resource, the GSM DRx subscription associated with SIM1 needs to perform reacquisition operations in the time period 312 as a result of declaring a system loss. The reacquisition operations of the GSM DRx subscription associated with SIM3 are illustrated as occurring in time period 314. Thus, as illustrated in the timeline diagram 300, the voice call in the time period 308 resulted in reacquisition operations by all subscriptions during the time periods 310, 312, and 314 that monopolize the RF resource for relatively longer periods of time than would be expected in normal slotted operations.

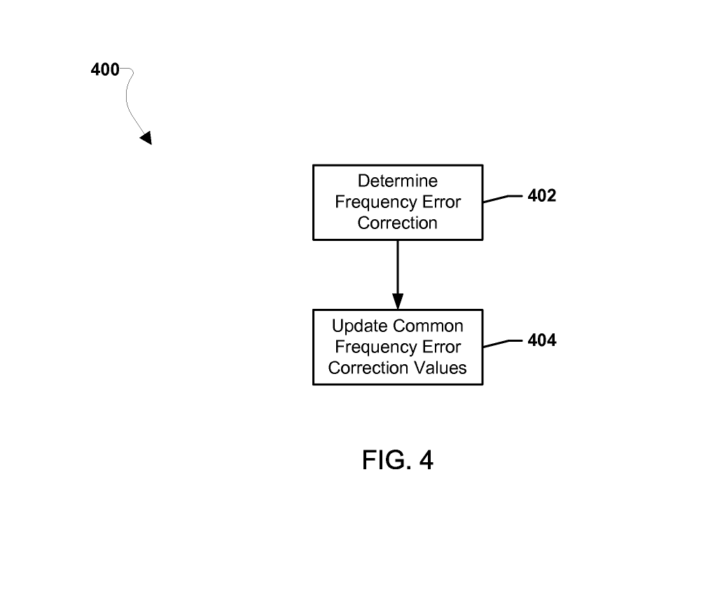

FIG. 4 illustrates a method 400 for updating common frequency error correction values according to various embodiments. With reference to FIGS. 1-4, the method 400 may be implemented with a processor (e.g., the general processor 206, the baseband modem processor 216, a separate controller, and/or the like) of an SRLTE communication device (e.g., the SRLTE communication device 110, 120, 200 described with reference to FIGS. 1-3). In various embodiments, the operations of the method 400 may be performed when a subscription, such as a CDMA 2000 1× subscription or GSM DRx subscription, or entity other than a subscription, such as a common frequency error manager of the modem, a common frequency error management unit of a reacquisition management unit separate from the modem, etc., controls the RF resource (e.g., RF resource 218) of the SRLTE communication device (e.g., the SRLTE communication device 110, 200 described with reference to FIGS. 1-3).

In block 402, the processor the SRLTE communication device may determine a frequency error correction value. In block 404, the processor of the SRLTE communication device may use the frequency error correction value to update common frequency error correction values stored in memory (e.g., 214). Common frequency error correction values stored in memory may be frequency error correction values that are stored in a memory location common to (i.e., accessible by) all subscriptions of the SRLTE communication device such that the common frequency error correction values stored in the memory location may be used by all subscriptions of the SRLTE communication device.

In some embodiments, when a subscription controlling the RF resource at a given time determines a frequency error correction, the subscription controlling the RF resource may pass that determined frequency error correction to an entity on the SRLTE device that tracks frequency errors, such as a common frequency error manager of the modem, a common frequency error management unit of a reacquisition management unit separate from the modem, etc. The entity on the SRLTE device that tracks frequency errors may update a common listing of frequency error corrections that is stored in a memory (e.g., 214) for use by all subscriptions of the SRLTE communication device stored in a memory.

In some embodiments, when a subscription controlling the RF resource at a given time determines a frequency error correction, the subscription may store the frequency error correction in a memory (e.g., 214) location dedicated to common frequency error correction values storage that is common to (i.e., accessible by) all subscriptions of the SRLTE communication device.

In some embodiments, an entity of the SRLTE device other than a subscription, such as a common frequency error manager of the modem, a common frequency error management unit of a reacquisition management unit separate from the modem, etc., may control the RF resource at a given time and determine a frequency error correction. The entity of the SRLTE device other than a subscription may store the frequency error correction in memory (e.g., 214) in a location dedicated to common frequency error correction values storage that is common to (i.e., accessible by) all subscriptions of the SRLTE communication device.

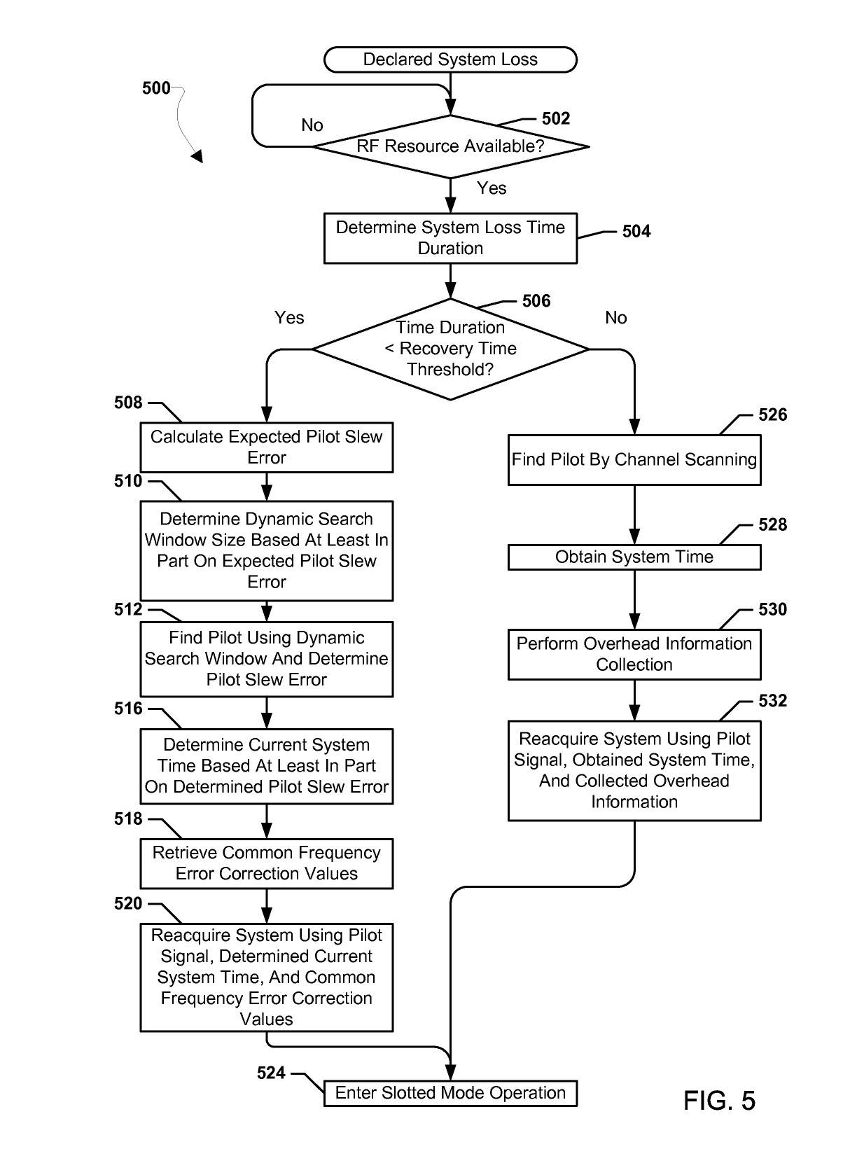

FIG. 5 illustrates a method 500 for reducing subscription reacquisition times in SRLTE communication devices according to various embodiments. With reference to FIGS. 1-5, the method 500 may be implemented with a processor (e.g., the general processor 206, the baseband modem processor 216, a separate controller, and/or the like) of an SRLTE communication device (e.g., the SRLTE communication device 110, 120, 200). In various embodiments, the operations of the method 500 may be performed when a subscription, such as a CDMA 2000 1× subscription, controls the RF resource (e.g., RF resource 218) of the SRLTE communication device (e.g., the SRLTE communication device 110, 200). The operations of the method 500 may be performed after a subscription has declared a system loss.

In determination block 502, the processor may determine whether the RF resource is available for the subscription. The RF resource may be available when another subscription or entity is not actively using the RF resource to conduct a higher priority action (e.g., conducting a data call). In response to determining that the RF resource is not available (i.e., determination block 502=“No”), the processor may continue to monitor for when the RF resource becomes available for the subscription in determination block 502.

In response to determining that the RF resource is available (i.e., determination block 502=“Yes”), the processor may determine a system loss time duration in block 504. In some embodiments, a system loss time duration may be equal to a time duration since the system loss was declared, which the processor may calculate as the difference between the current clock time of the SRLTE communication device and a time associated with the system loss declaration event.

In determination block 506, the processor may determine whether the time duration is less than a recovery time threshold. The recovery time threshold may be a value stored in memory (e.g., 214) that may be configurable by a user, original equipment manufacturer, and/or network operator. The recovery time threshold may represent an amount of time after which attempting to dynamically size a search window for a pilot signal may be of negligible value in improving the speed at which an active pilot signal or neighbor pilot signal may be found.

In response to determining that the time duration is greater than or equal to the recover threshold time (i.e., determination block 506=“No”), the processor may find a pilot by channel scanning in block 526. During channel scanning, the processor may control the RF resource to search for an active or neighbor pilot signal over every possible frequency for pilot signals.

After finding an active pilot signal or neighbor pilot signal by channel scanning, the processor may obtain the system time from the network in block 528. In block 530, the processor may perform overhead information collection. During overhead information collection the processor may determine error correction values and other information needed to reacquire signals from a network associated with the subscription.

In block 532 the processor may reacquire signals from the network associated with the subscription using the pilot signal, the obtained system time, and the collected overhead information. With the system reacquired, the processor may enter slotted mode operation and relinquish the RF resource to the next scheduled subscription in block 524. The entire process from finding a pilot channel in block 526 to entering slotted mode operation in block 524 may take, for example, 5 to 10 seconds.

In response to determining that the time duration is less than the recover threshold time (i.e., determination block 506=“Yes”), the processor may calculate the expected pilot slew error in block 508. The expected pilot slew error may be a frequency value derived based on the elapsed time since the subscription last had control of the RF resource and a characterized slew error previously determined by the subscription when it last had control of the RF resource. The characterized slew error may be derived by a subscription operating in a slotted mode each time the subscription has control of the RF resource and may be stored in a memory (e.g., 214) of the SRLTE communication device. The elapsed time since the subscription last had control of the RF resource (also sometimes referred to as a slept time) may be tracked by the subscription (e.g., by counting clock ticks) from the time that the subscription relinquished control of the RF resource. The expected pilot slew error may be determined as equal to the characterized slew error multiplied by a result of dividing the elapsed time since the subscription last had control of the RF resource by the subscription's slot cycle index. The subscription's slot cycle index may be a value stored in memory (e.g., 214) associated with the period of time allocated to the subscription to control the RF resource when operating in a slotted mode.

In block 510, the processor may determine a dynamic search window size based at least in part on the expected pilot slew error. For instance, the dynamic search window size may be a frequency range determined as equal to the current window size of the subscription plus the expected pilot slew error. The current window size may be a frequency range stored in a memory (e.g., 214) of the SRLTE communication device over which the subscription may attempt to find active or neighbor pilot signals.

In block 512, the processor may find the pilot signal using the dynamic search window size and determine the pilot slew error. For example, the processor may use the dynamic search window size to search for all active and available neighbor pilots in that frequency range and thereby find a pilot signal. In this manner, the subscription may avoid channel scanning for all possible pilots, enabling the pilot signal to be located within the dynamic search window size faster than a pilot would have been acquired by channel scanning. In block 513, the processor may determine a pilot slew error. For example, once a pilot is found using the determined search window size, the pilot may be used to determine the pilot slew error as a value of time.

In block 516, the processor may determine the current system time based at least in part on the determined pilot slew error. For example, the elapsed time since the subscription last had control of the RF resource (also sometimes referred to as a slept time) plus the determined pilot slew error may be equal to the current system time. In some embodiments, the elapsed time since the subscription last had control of the RF resource (also sometimes referred to as a slept time) may be tracked by the subscription counting clock ticks from the time the subscription relinquished control of the RF resource.

In block 518, the processor may retrieve the common frequency error correction values stored in memory (e.g., 214) that were determined by another subscription or another entity other than a subscription, such as common frequency error correction values determined according to method 400 described. Common frequency error correction values may be frequency error correction values stored in a memory location common to all subscriptions of the SRLTE communication device such that the common frequency error correction values stored in the memory location may be used by all subscriptions of the SRLTE communication device. In some embodiments, the processor may read the values from a memory (e.g., 214) location dedicated to the common frequency values. In some embodiments, the processor may request the values from a reacquisition management unit of a common frequency error management unit.

In block 520, the processor may reacquire signals from a network associated with the subscription using the pilot signal, the determined current system time, and the common frequency error correction values. This system reacquisition using the pilot signal, the determined current system time, and the common frequency error correction values in blocks 508-520 may be faster than the reacquisition using a pilot signal, a network obtained system time, and collected overhead information in blocks 526-532. For example, a CDMA 2000 1× subscription performing reacquisition using the pilot signal, the determined current system time, and the common frequency error correction values may take less than 100 milliseconds to reacquire signals from a network associated with the subscription. With the system reacquired, the processor may enter slotted mode operation and relinquish the RF resource to the next scheduled subscription in block 524.

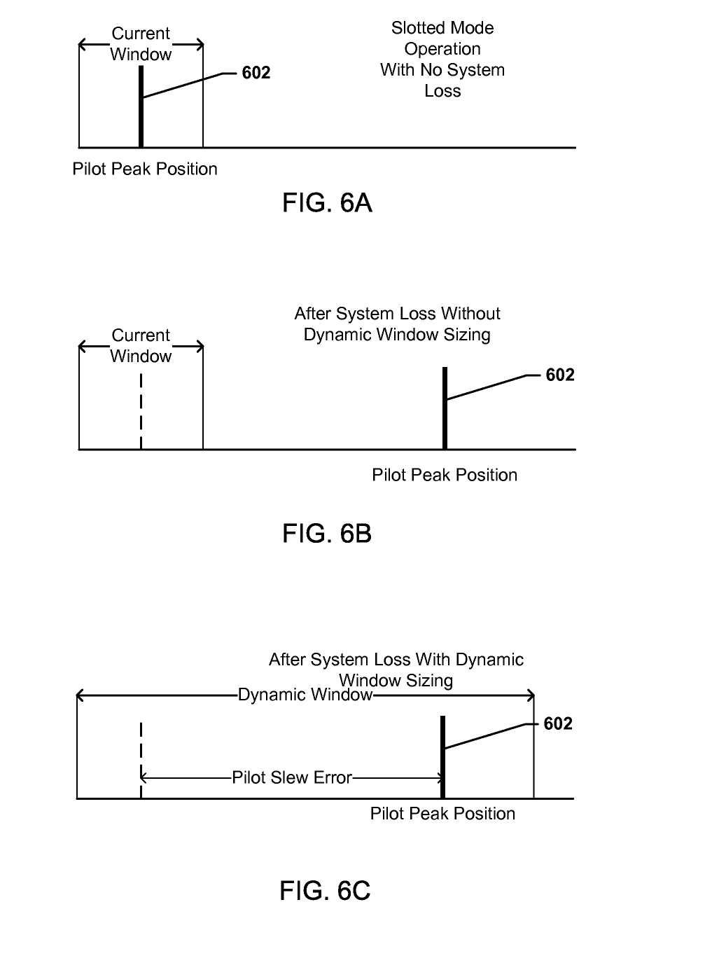

Reasons for determining a dynamic search window size in block 510 of the method 500 are illustrated in the frequency diagrams 610, 620, 630 provided in FIGS. 6A-6C. With reference to FIGS. 1-6C, the current window will overlap a pilot peak position of a pilot signal 602 in the slotted mode when no system loss has occurred as illustrated in the frequency diagram 610. When no system loss has occurred, the pilot signal 602 may fall within the current window in the slotted mode because the subscription receives control of the RF resource at regular intervals and the pilot signal 602 will fall in the current window.

The frequency diagram 620 illustrates movement of the pilot signal 602 during the system loss of the subscription when the RF resource was unavailable. In the frequency diagram 620, the pilot signal 602 has moved during the system loss time period and the current window no longer covers frequencies including the pilot signal 602. Thus, using only the current window will not result in finding the pilot signal.

The frequency diagram 630 illustrates a dynamic window that has been determined to compensate for the shift in pilot signal frequency 602 over time during the system loss of the subscription when the RF resource was unavailable. As illustrated in the frequency window 630, the pilot signal 602 has moved during the system loss time period by the pilot slew error, but by adding the expected pilot slew error to the current window size, a dynamic window size is determined that encompasses the pilot signal 602. Thus, the pilot signal 602 can be found by searching only within the dynamic window.

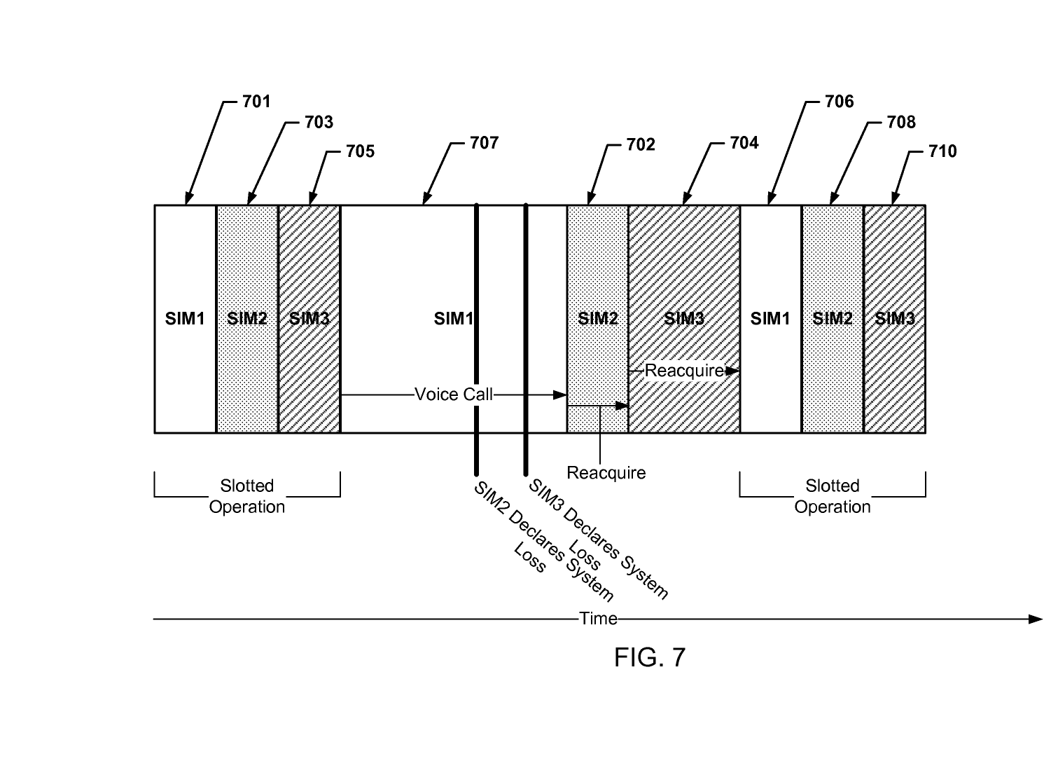

FIG. 7 is a timeline diagram 700 illustrating control of an RF resource of an SRLTE communication device (e.g., 110, 120, 200 in FIGS. 1-2) by a GSM DRx subscription associated with SIM1, a CDMA 2000 1× subscription associated with SIM2, and a GSM DRx subscription associated with SIM3 of an SRLTE communication device. With reference to FIGS. 1-7, initially the three subscriptions SIM1, SIM2, and SIM3 may be operating in a slotted mode periodically passing control of the RF resource among one another. For example, SIM1 may control the RF resource for a time period 701 of 470 milliseconds, after which SIM2 may control the RF resource for a time period 703 of 470 milliseconds, and then SIM3 may control the RF resource for a time period 705 of 470 milliseconds.

In time period 707, the GSM DRx subscription associated with SIM1 may conduct a voice call, and during the voice call may not relinquish control of the RF resource to the other subscriptions associated with SIM2 and SIM3. The long duration that the subscriptions associated with SIM2 and SIM3 may go without monitoring each subscription's respective networks via the RF resource may cause SIM2 and SIM3 to declare a system loss. For example, the CDMA 2000 1× subscription associated with SIM2 may declare a system loss when the RF resource is not available for more than 1 minutes because after a minute without controlling the RF resource the CDMA 2000 1× subscription associated with SIM2 is unable to track network time, clock drift and clock errors may occur, and potentially the SRLTE communication device may have moved out of a coverage area.

In time period 702, the CDMA 2000 1× subscription associated with SIM2 may reacquire signals from a network associated with the subscription according to the operations of method 500 using dynamic search window sizing. The CDMA 2000 1× subscription associated with SIM2 may reacquire signals from the network associated with the subscription within 100 milliseconds, and relinquish control to the GSM DRx subscription associated with SIM3, which may reacquire the GSM DRx subscription system in time period 704. The period of time for the CDMA 2000 1× subscription associated with SIM2 and GSM DRx subscription associated with SIM3 to both reacquire the systems supporting the subscriptions may be less than the time at which GSM DRx subscription associated with SIM1 would declare a system loss. At time period 706 GSM DRx subscription associated with SIM1 may regain the RF resource and all three subscriptions may resume slotted operations in the time periods 706, 708, and 710. As illustrated by a comparison of the timeline diagrams 300 and 700, the use of a dynamic search window may enable a faster return to slotted operations after a voice call, resulting in less missed MT pages and less system loss time.

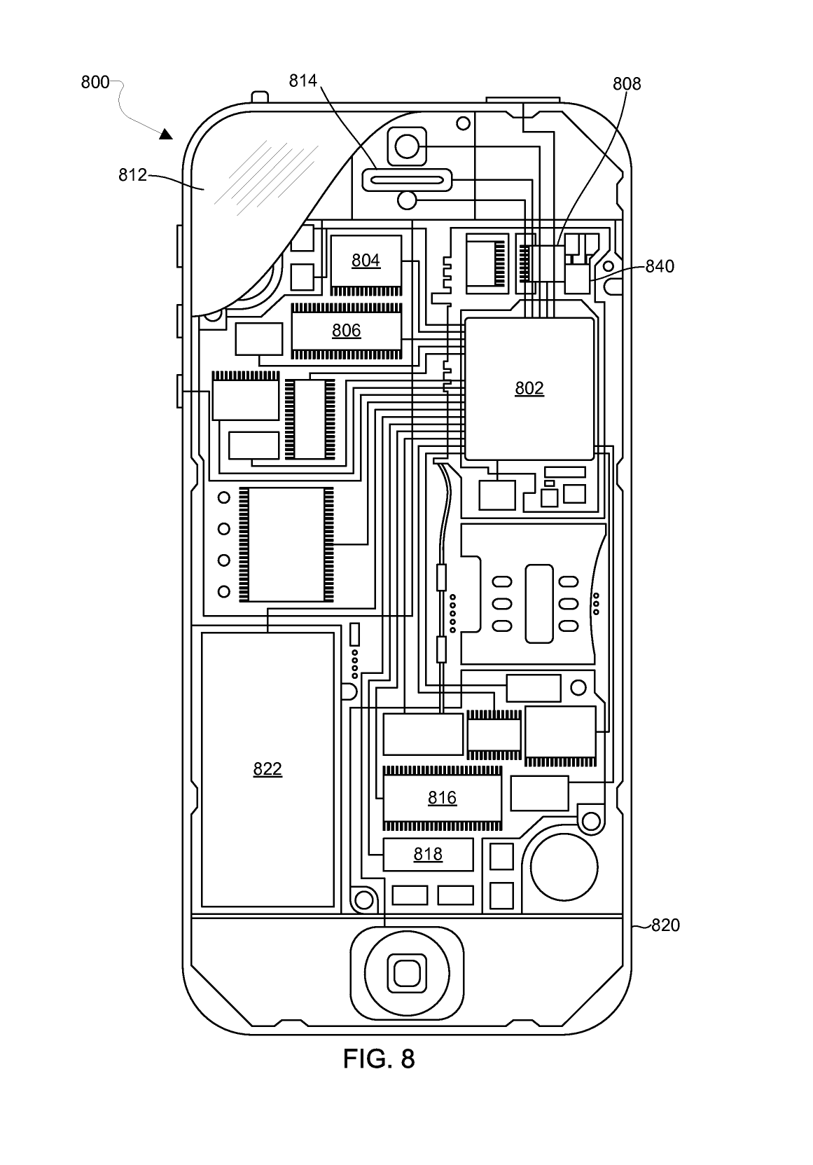

Various embodiments may be implemented in any of a variety of communication devices, an example on which (e.g., SRLTE communication device 800) is illustrated in FIG. 8. With reference to FIGS. 1-8, the SRLTE communication device 800 may be similar to the SRLTE communication devices 110, 120, 200 and may implement the method 400 and/or the method 500 as described.

The SRLTE communication device 800 may include a processor 802 coupled to a touchscreen controller 804 and an internal memory 806. The processor 802 may be one or more multi-core integrated circuits designated for general or specific processing tasks. The internal memory 806 may be volatile or non-volatile memory, and may also be secure and/or encrypted memory, or unsecure and/or unencrypted memory, or any combination thereof. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the SRLTE communication device 800 need not have touch screen capability.

The SRLTE communication device 800 may have one or more cellular network transceivers 808, 816 coupled to the processor 802 and to one or more antennae 810, 811 and configured for sending and receiving cellular communications. The transceivers 808, 816 and the antennae 810, 811 may be used with the above-mentioned circuitry to implement the methods of various embodiments. The SRLTE communication device 800 may include one or more SIM cards (e.g., SIM 813) coupled to the transceivers 808, 816 and/or the processor 802 and configured as described. The SRLTE communication device 800 may include a cellular network wireless modem chip 817 that enables communication via a cellular network and is coupled to the processor 802.

The SRLTE communication device 800 may also include speakers 814 for providing audio outputs. The SRLTE communication device 800 may also include a housing 820, constructed of a plastic, metal, or a combination of materials, for containing all or some of the components discussed herein. The SRLTE communication device 800 may include a power source 822 coupled to the processor 802, such as a disposable or rechargeable battery. The rechargeable battery may also be coupled to the peripheral device connection port to receive a charging current from a source external to the SRLTE communication device 800. The SRLTE communication device 800 may also include a physical button 824 for receiving user inputs. The SRLTE communication device 800 may also include a power button 826 for turning the SRLTE communication device 800 on and off.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to some embodiments without departing from the scope of the claims. Thus, the present disclosure is not intended to be limited to the examples shown herein but is to be accorded the widest scope consistent with the following claims and the principles and novel features disclosed herein.

1. A method for reacquiring a network following a declared system loss in a single radio long term evolution (SRLTE) communication device, comprising:
calculating an expected pilot slew error in response to a radio frequency (RF) resource of the SRLTE communication device becoming available to a first subscription of the SRLTE communication device following a declared system loss of the first subscription;
determining a dynamic search window size based at least in part on the expected pilot slew error;
finding a pilot signal using the dynamic search window size; and
reacquiring a network associated with the first subscription using the pilot signal.

2. The method of claim 1, further comprising:
determining a pilot slew error based on the pilot signal; and
determining a current system time based at least in part on the pilot slew error,
wherein reacquiring the network associated with the first subscription using the pilot signal comprises reacquiring the network associated with the first subscription using the pilot signal and the current system time.

3. The method of claim 2, wherein determining a current system time based at least in part on the pilot slew error comprises:
determining a current system time as an elapsed time since the first subscription last had control of the RF resource plus the pilot slew error.

4. The method of claim 2, further comprising:
retrieving a common frequency error correction value from a memory of the SRLTE communication device,
wherein reacquiring the network associated with the first subscription using the pilot signal and the current system time comprises reacquiring the network associated with the first subscription using the pilot signal, the current system time, and the common frequency error correction value.

5. The method of claim 4, further comprising:
determining the common frequency error correction value by a second subscription of the SRLTE communication device.

6. The method of claim 4, further comprising:
determining the common frequency error correction value by an entity of the SRLTE communication device other than a subscription.

7. The method of claim 1, wherein determining a dynamic search window size based at least in part on the expected pilot slew error comprises determining a dynamic search window size as a current window size plus the expected pilot slew error.

8. The method of claim 1, wherein calculating an expected pilot slew error comprises:
calculating an expected pilot slew error based at least in part on an elapsed time since the first subscription last had control of the RF resource and a characterized slew error stored in a memory of the SRLTE communication device.

9. A single radio long term evolution (SRLTE) communication device, comprising:
a radio frequency (RF) resource; and
a processor coupled to the RF resource and configured with processor-executable instructions to:
calculate an expected pilot slew error in response to the RF resource becoming available to a first subscription of the SRLTE communication device following a declared system loss of the first subscription;
determine a dynamic search window size based at least in part on the expected pilot slew error;
find a pilot signal using the dynamic search window size; and
reacquire a network associated with the first subscription using the pilot signal.

10. The SRLTE communication device of claim 9, wherein the processor is further configured with processor-executable instructions to:
determine a pilot slew error based on the pilot signal;
determine a current system time based at least in part on the determined pilot slew error; and
reacquire the network associated with the first subscription using the pilot signal by reacquiring the network associated with the first subscription using the pilot signal and the determined current system time.

11. The SRLTE communication device of claim 10, wherein the processor is configured with processor-executable instructions to:
determine a current system time based at least in part on the determined pilot slew error by determining a current system time as an elapsed time since the first subscription last had control of the RF resource plus the determined pilot slew error.

12. The SRLTE communication device of claim 10, wherein the processor is configured with processor-executable instructions to:
retrieve a common frequency error correction value from a memory of the SRLTE communication device; and
reacquire the network associated with the first subscription using the pilot signal and the determined current system time by reacquiring the network associated with the first subscription using the pilot signal, the determined current system time, and the common frequency error correction value.

13. The SRLTE communication device of claim 12, wherein the processor is configured with processor-executable instructions to:
determine the common frequency error correction value by a second subscription of the SRLTE communication device.

14. The SRLTE communication device of claim 12, wherein the processor is configured with processor-executable instructions to:
determine the common frequency error correction value by an entity of the SRLTE communication device other than a subscription.

15. The SRLTE communication device of claim 9, wherein the processor is further configured with processor-executable instructions to:
determine a dynamic search window size based at least in part on the expected pilot slew error by determining a dynamic search window size as a current window size plus the expected pilot slew error.

16. The SRLTE communication device of claim 9, wherein the processor is further configured with processor-executable instructions to:
calculate an expected pilot slew error by calculating an expected pilot slew error based at least in part on an elapsed time since the first subscription last had control of the RF resource and a characterized slew error stored in a memory of the SRLTE communication device.

17. A non-transitory processor-readable storage medium having stored thereon processor-executable instructions configured to cause a processor of a single radio long term evolution (SRLTE) communication device to perform operations for reacquiring a network following a declared system loss comprising:
calculating an expected pilot slew error in response to a radio frequency (RF) resource of the SRLTE communication device becoming available to a first subscription of the SRLTE communication device following a declared system loss of the first subscription;
determining a dynamic search window size based at least in part on the expected pilot slew error;
finding a pilot signal using the dynamic search window size; and
reacquiring a network associated with the first subscription using the pilot signal.

18. The non-transitory processor-readable storage medium of claim 17, wherein the stored processor-executable instructions are configured to cause a processor of a SRLTE communication device to perform operations further comprising:
determining a pilot slew error based on the pilot signal; and
determining a current system time based at least in part on the pilot slew error,
wherein the stored processor-executable instructions are configured to cause a processor of a SRLTE communication device to perform operations such that reacquiring the network associated with the first subscription using the pilot signal comprises reacquiring the network associated with the first subscription using the pilot signal and the current system time.

19. The non-transitory processor-readable storage medium of claim 18, wherein the stored processor-executable instructions are configured to cause a processor of a SRLTE communication device to perform operations such that determining a current system time based at least in part on the pilot slew error comprises determining a current system time as an elapsed time since the first subscription last had control of the RF resource plus the pilot slew error.

20. The non-transitory processor-readable storage medium of claim 18, wherein the stored processor-executable instructions are configured to cause a processor of a SRLTE communication device to perform operations further comprising retrieving a common frequency error correction value from a memory of the SRLTE communication device,
wherein the stored processor-executable instructions are configured to cause a processor of a SRLTE communication device to perform operations such that reacquiring the network associated with the first subscription using the pilot signal and the current system time comprises reacquiring the network associated with the first subscription using the pilot signal, the current system time, and the common frequency error correction value.

21. The non-transitory processor-readable storage medium of claim 20, wherein the stored processor-executable instructions are configured to cause a processor of a SRLTE communication device to perform operations further comprising determining the common frequency error correction value by a second subscription of the SRLTE communication device.

22. The non-transitory processor-readable storage medium of claim 20, wherein the stored processor-executable instructions are configured to cause a processor of a SRLTE communication device to perform operations further comprising determining the common frequency error correction value by an entity of the SRLTE communication device other than a subscription.

23. The non-transitory processor-readable storage medium of claim 17, wherein the stored processor-executable instructions are configured to cause a processor of a SRLTE communication device to perform operations such that determining a dynamic search window size based at least in part on the expected pilot slew error comprises determining a dynamic search window size as a current window size plus the expected pilot slew error.

24. The non-transitory processor-readable storage medium of claim 17, wherein the stored processor-executable instructions are configured to cause a processor of a SRLTE communication device to perform operations such that calculating an expected pilot slew error comprises calculating an expected pilot slew error based at least in part on an elapsed time since the first subscription last had control of the RF resource and a characterized slew error stored in a memory of the SRLTE communication device.

25. A single radio long term evolution (SRLTE) communication device, comprising:
means for calculating an expected pilot slew error in response to a radio frequency (RF) resource of the SRLTE communication device becoming available to a first subscription of the SRLTE communication device following a declared system loss of the first subscription;
means for determining a dynamic search window size based at least in part on the expected pilot slew error;
means for finding a pilot signal using the dynamic search window size; and
means for reacquiring a network associated with the first subscription using the pilot signal.
